(19) United States
(12) Patent Application Publication
(10) Pub. No.: US 2008/0067775 A1
(43) Pub. Date: Mar. 20, 2008

(54) Vehicle step attachable to side of receiver type hitch

(76) Inventors: Emidio Joseph DiCarlo, Franklin, MA (US); David M. Armstrong, Hopkinton, MA (US)

Correspondence Address: LAW OFFICE OF BRETT N. DORNY, 386 WEST MAIN STREET, SUITE 12A, NORTHBOROUGH, MA, 01532, US

(21) Appl. No.: 11/524,058

(22) Filed: Sep. 19, 2006

(51) Int. Cl. B60R 3/00

(52) U.S. Cl. 280/166

(57) ABSTRACT

A step for a large pickup truck has a tubular extension member having a square cross section. The extension member is sized to fit within the tubular end of a receiver type hitch. A stepping platform is attached to the top of the extension member. The extension member extends from the side of the receiver type hitch a sufficient distance to function as a step to the tailgate or bed of the truck. A ring on the extension member prevents it from being inserted too far into the hitch. A chain connected to the ring is attachable to the hitch to prevent the accidental removal of the step. The chain and ring can be positioned to allow the step to be moved between extended and non-extended positions.

### BACKGROUND OF THE INVENTION

1. Field of the Invention

The present invention relates to a step for a large vehicle. More particularly, it relates to a step for access to the rear of a large pickup truck which attaches to a receiver-type hitch.

2. Discussion of Related Art

The use of large pickup trucks has increased. However, reaching the bed of a large pickup truck can be difficult. Often it is relatively high off the ground, approximately in the range of three to four feet. Therefore, a step is needed to be able to reach into the bed or to assist in getting up to the tailgate to enter the bed of the truck.

A variety of step designs exist for attachment to the rear of a truck to aid in reaching the vehicle. These steps can be difficult to use. They may be in the way when not needed. They often stick out from the rear of the vehicle and can be a hazard to those working around the vehicle. Other steps are known to attach to a receiver type hitch for a vehicle. These may prevent use of a hitch and must be removed before the truck can be used for towing purposes. Alternatively, some steps incorporate a hitch into their structure. However, with these steps, the entire structure must be designed and constructed to provide sufficient strength for towing a large vehicle. This makes such steps fairly expensive. Furthermore, when the tailgate of the truck is opened, it will cover the steps. Complex structures are required to move the steps between a close position and an extended position. The close position can be used when the tailgate is closed and the extended position can be used when the tailgate is opened.

Therefore, a need exists for a truck step which is simple, easy to use, does not interfere with a hitch, and inexpensive.

### SUMMARY OF THE INVENTION

The present invention provides an simple, inexpensive step through connecting to the side of a receiver type hitch. The step includes an extension bar and a platform. The extension bar is sized to fit within the tubular side of a receiver type hitch. The platform is attached to the top of the extension bar. According to one aspect of the invention, the platform includes a non-skid surface. According to another aspect of the invention, the extension bar includes at least one bend.

According to another aspect of the invention, the step includes an attachment mechanism for holding it in place in the receiver type hitch. According to another aspect of the invention, the attachment mechanism allows the step to be moved between an extended position and a non-extended position.

### BRIEF DESCRIPTION OF THE DRAWINGS

FIG. 1 is a perspective view of a step according to an embodiment of the present invention.

FIGS. 2A and 2b are side view and top view, respectively, of the step of FIG. 1.

FIG. 3 is a perspective view of a step according to an embodiment of the present invention connected to a receiver type hitch.

FIGS. 4A-4C are side views of alternative structures for attaching the step to a receiver type hitch.

FIGS. 5A and 5B are side views of steps according to alternative embodiments of the present invention.

FIGS. 6A and 6B are side and end views, respectively, of an alternative embodiment of the present invention.

FIG. 7 is a side view of a receiver type hitch having a step according to an embodiment of the present invention.

### DETAILED DESCRIPTION

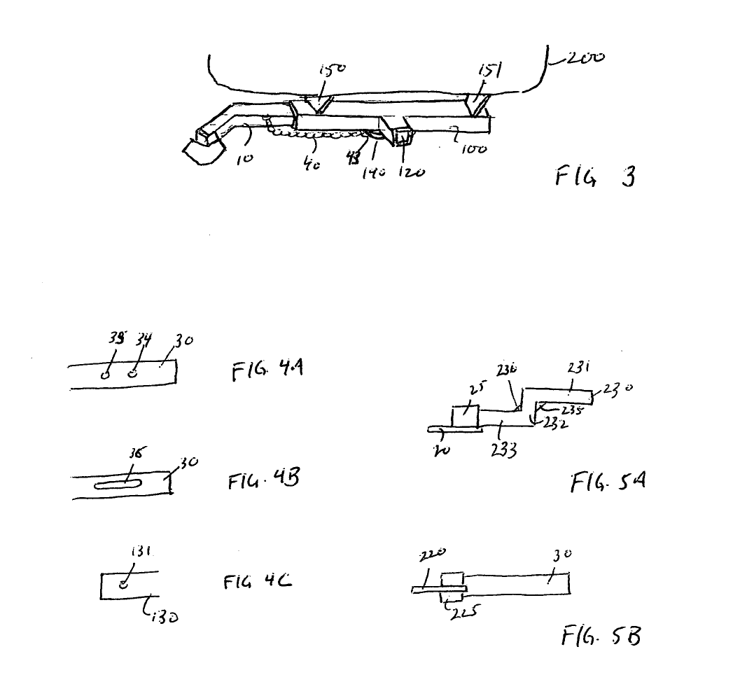

The present invention provides a step for a large pickup truck which attaches to the side of a receiver type hitch. Receiver type hitches 100 have commonly known structures for connecting a trailer to a vehicle, as illustrated in FIG. 3. The hitch structure includes a cross bar 130 which is attached with brackets 150, 151 to the undercarriage of a vehicle 200. The cross bar 130 is formed as a tube having a square shaped cross section. A connector 120, also of a tube with a square shaped cross section, extends perpendicularly from the cross bar in approximately the center. The connector 120 is designed to accept a receiver (not shown). The hitch ball is connected to the receiver, which may include a drop or rise. A hole in the receiver and the connector accommodates a pin to keep the receiver in place. When the vehicle is not being used for towing, the receiver can be removed from the connector. Known truck steps are designed to attach to the connector 120 in place of a receiver. However, such a design interferes with use of the hitch for towing purposes.

The present invention includes a step which connects with the cross bar 130 of the receiver type hitch. Typically, in a receiver type hitch, the cross bar 130, similarly to the connector 120, includes a square shaped tubular opening on the ends near the brackets 150, 151. An embodiment of a step 10 of the present invention is illustrated in FIG. 1. The step 10 includes an extension bar 30 and a platform 20. The extension bar 30 is a metal tube having a square cross section. Of course, the extension bar 30 could be formed as a solid metal bar. However, a tube is sufficiently strong to function as a step and weighs less than a solid bar. It can be formed using an extrusion process or by folding a metal sheet and welding the ends.

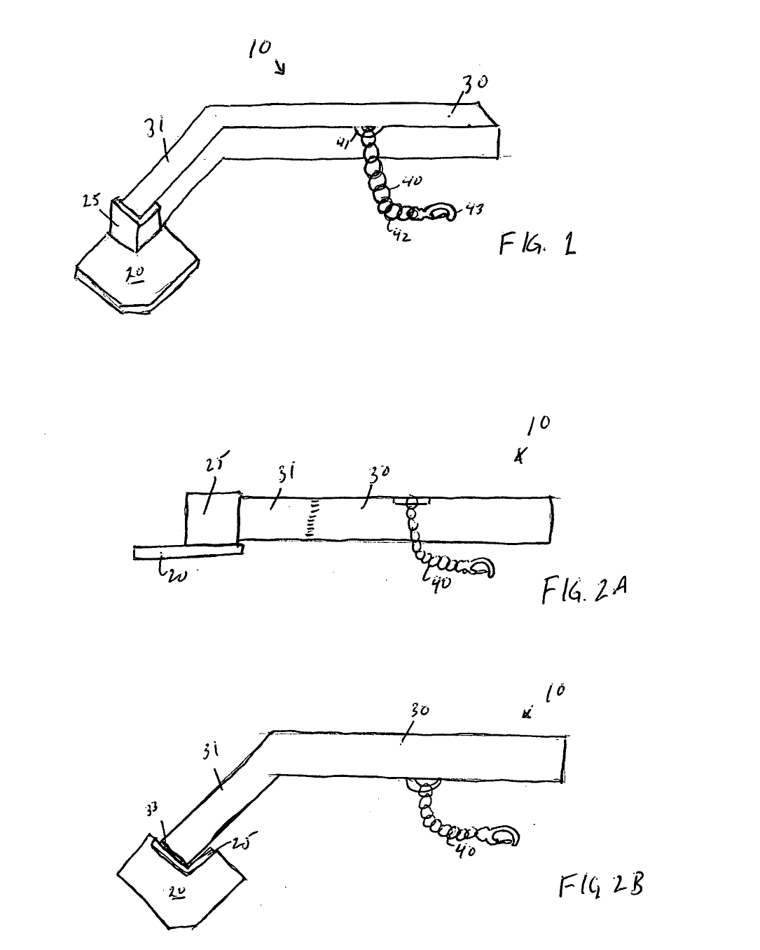

FIGS. 2A and 2B are side and top views, respectively, of the step 10 of FIG. 1. The relationship between the platform 20 and the extension bar 30. The platform 20 is formed of a sheet of metal sized and shaped to function as a step. It may be flat or have a dimpled surface. The top surface should be non-skid, either through formation of the platform, attachment of a non-skid material, or application of a non-skid paint. A toe kick 25 is attached to the end of the extension bar 30. As illustrated in FIGS. 2A and 2B, the toe kick 25 is formed of an L-shaped piece of metal. It can be formed with the extension bar 30, welded to it, or otherwise attached in a manner have sufficient strength to support a person standing on the step. The platform 20 is connected to the toe kick 25. The toe kick 25 provides a strong connection between the platform 20 and the extension bar 30. It also helps to position the foot of the user on the step to prevent falls.

According to an embodiment of the present invention, as illustrated in FIG. 1, the extension bar 30 includes a bend to form an angled member 31. The angled member 31 allows the step to be properly positioned relative to the rear and tailgate of the vehicle. The hitch 100 is positioned under the vehicle. The extension bar 30 may extend straight out the side of the vehicle. However, for easier access to the rear of the vehicle, the angled member 31 is included so that the platform 20 is positioned at the rear of the vehicle. The desired angle between the extension bar 30 and the angled member 31 will depend upon the design of the vehicle with which the step is used and the position of the hitch relative to the vehicle.

For easy insertion and removal of the step from the hitch, the outer dimensions of the extension bar 30 are slightly smaller than the interior dimensions of the cross bar 130 of the hitch 100. A chain structure 40 is used to keep the step in a desirable position relative to the cross bar 130. A ring 41 is welded to the extension bar 30. As illustrated in FIG. 1, the ring 41 is welded to a top surface of the extension bar 30. The ring 41 could be welded to any position on the extension bar 30. The ring 41 extends from the extension bar 30 so that the ring 41 contacts the cross bar 130 when the step 10 is in place. The ring 41 prevents the step 10 from being inserted too far into the cross bar 130. A chain 42, having a releasable connector 43, is attached to the ring 41. A hitch 100 includes a ring 140 at the connector 120 for attaching safety chains from the vehicle being towed. The releasable connector 43 can be connected to this ring 140. The chain 42 is of a length that the step 10 cannot be removed from the cross bar 120 without disconnecting the chain structure 40. Thus, the position of the step relative to the hitch and the vehicle is properly maintained.

Furthermore, when used as a step, it may be desirable to have the platform 20 extend from the side of the vehicle. However, when driving the vehicle, or when the step is not being used, it may be desirable, and safer, to have the platform under the vehicle. The chain structure 40 accommodates this operation. The step 10 can be easily slid from a first position under the vehicle to a second position extending from the vehicle. The ring 41 contacts the cross bar 130 when the step 10 is slid into the first position. The chain 42 keeps the step 10 in the cross bar 130 when it is slid out to the second position. Thus, the ring 41 and chain 42 are positioned and sized to control the first and second positions for the step.

FIGS. 3A-3C illustrate alternative structures to the chain structure 40 for retaining the step in the hitch and controlling its position. For the structures illustrated in FIGS. 3A-3C, a pin is used to keep the step in position. FIG. 3A illustrates the extension bar 30. It includes two holes 33, 34 in the extension bar 30 at different positions. A similarly sized hole 131 is in the cross bar 130, as illustrated in FIG. 3C. Then the step is inserted into the cross bar, one of the holes 33, 34 in the extension bar 30 is aligned with the hole in the cross bar 130. A pin (not shown) is inserted into the holes to keep the extension bar 30 in position. Which hole 33, 34 in the extension bar 30 to use depends upon the desired position of the step, either extended or non-extended.

FIG. 3B illustrates another embodiment of the extension bar 30. For the extension bar 30 illustrated in FIG. 3A, the pin must be removed to change the step between the extended and non-extended positions. As illustrated in FIG. 3B, a slot 35 is used instead of two holes. The pin is inserted in the hole 131 of the cross bar 130 and into the slot 35 of the extension bar 30. The step 10 can be slid between the extended and non-extended positions as the pin moves in the slot 35.

FIGS. 5A and 5B illustrate additional embodiments of the present invention. These embodiments allow the step 10 to function with different types of vehicles. For some vehicles, the height of the hitch off the ground is too high for comfortable use of a step. FIG. 5A illustrates an embodiment of the extension bar 230 for use on such a vehicle. The extension bar 230 is formed of three parts 231, 232, 233. The parts may be formed as a single unit when the extension bar is constructed. Alternatively, the parts could be welded together after they are formed. The extension bar 230 includes a step down section 232 between the part which extends from the hitch (231) and the part which is attached to the step (233). The step down 232 is of appropriate length to make a comfortable step from the ground.

When the extension bar 30 includes an angled member 31 as illustrated in FIG. 1, it can only be used on one side of the vehicle. Different steps must be used for each side. Alternatively, the platform 220 centered on the toe kick 225 as illustrated in FIG. 5B. With this embodiment, the step 10 can be inverted 180 degrees when inserted in the hitch 100. In either position, the platform 220 functions as a step. The angled member 31 allows correct positioning of the step relative to the rear of the vehicle.

The cross bars for some hitches 100 do not have a square cross section. FIGS. 6A and 6B illustrate an embodiment of the step of the present invention which can be used with cross bars having circular cross sections. A connector 300 is attached, preferably by welding, to the end of the extension bar 30. The extension bar 30 may have a square, circular, or other shaped cross section. The connector 300 includes a base plate 320, a tube 310, and a support 330. The tube 310 extends from the base plate 320 such that central axes of the tube 310 and extension bar 30 are approximately aligned. The tube 310 is sized to fit within the cross bar 350 of hitch (illustrated in dashed form in FIG. 6B) having a circular cross. The support 330 also extends from the base plate 320. The support member 330 is sized and shaped to fit around a support bracket 355 of the hitch 350. FIG. 6B illustrates a support member 330 positioned below the cross bar. However, the support member 330 can be positioned anywhere to accommodate the support bracket of the hitch.

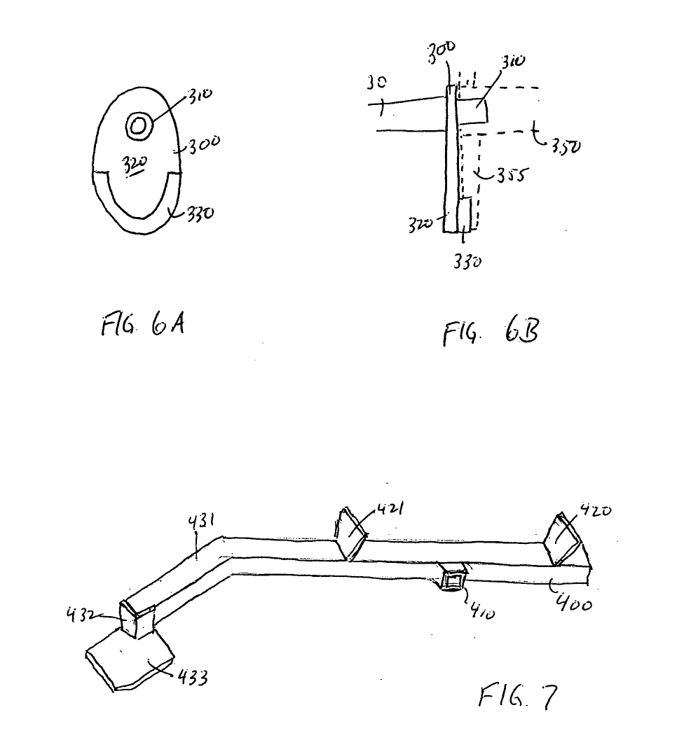

The steps of the prior embodiments are removably attached to a cross bar of a hitch. However, a step could be integrally formed with the cross bar as illustrated in FIG. 7. As with a typical hitch, the hitch of this embodiment includes a receiver 410 and a cross bar 430. It connected to the vehicle with support brackets 420, 421. In this embodiment, however, the cross bar 430 of the hitch extends past the support bracket 421 for the hitch 400. A platform 433 is attached to the end of the extended cross bar 430. A toe kick 432 may also be used. Additionally, depending upon the design of the vehicle, the cross bar may include an angled member 431, as in the embodiment of FIG. 1. FIG. 7 illustrates a step on one end of the hitch cross bar 430. Of course, steps could be formed on either side or on both sides of the cross bar 430.

Having disclosed at least one embodiment of the present invention, various adaptations, modifications, additions, and improvements will be readily apparent to those of ordinary skill in the art. Such adaptations, modifications, additions and improvements are considered part of the invention which is only limited by the several claims attached hereto.

1. A step for a vehicle having a receiver type tow hitch, the tow hitch including a tubular cross bar, the step comprising:
an extension having a first end which fits within the tubular cross bar of the tow hitch; and
a platform attached to a second end of the extension opposite the first end.

2. The step according to claim 1, further comprising:
a toe kick positioned between the extension and the platform.

3. The step according to claim 1 wherein the platform includes a non-skid surface.

4. The step according to claim 1, wherein the extension includes an first part having the first end and a second part having the second end, wherein the first part and second part are connected together at an angle.

5. The step according to claim 4, wherein the angle positions the platform at the rear of a vehicle to which the tow hitch is attached.

6. The step according to claim 4, wherein the angle provides a drop so that the platform is at a lower level than the tow hitch.

7. The step according to claim 1 further comprising a connector attached to the extension for maintaining a position between the extension and the tow hitch.

8. The step according to claim 7, wherein the connector includes:
a chain attached to the extension; and
a clip attached to the chain which is attachable to the two hitch.

9. The step according to claim 7, wherein the connector allows the extension to be moved from a first position to a second position relative to the tow hitch.

10. The step according to claim 1, wherein the platform is attached along a central axis of the extension.

11. The step according to claim 1, wherein the extension has a square cross section.

12. The step according to claim 1, wherein the tow hitch includes a cross bar having a circular cross section and a support assembly connecting an end of the cross bar the vehicle, wherein the first end of the extension includes:
a base plate;
a tube extending from a first side of the base plate, the tube being sized to fit within the cross bar; and
a support extending from the first side of the base plate, the support fitting around the support assembly of the tow hitch to prevent rotation of the tube within the cross bar.

13. A tow hitch for a vehicle comprising:
a cross bar;
a plurality of support assemblies connecting the cross bar to the vehicle; and
at least one platform providing a step attached to an end of the cross bar.
